(19) United States
(12) Patent Application Publication
(10) Pub. No.: US 2009/0034877 A1
(43) Pub. Date: Feb. 5, 2009

(54) METHOD AND DEVICE FOR MODIFYING THE SIZE OF AN IMAGE

(75) Inventor: Christophe Kefeder, Camon (FR)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: KONINKLIJKE PHILIPS ELECTRONICS N.V., Eindhoven (NL)

(21) Appl. No.: 11/721,160

(22) PCT Filed: Nov. 30, 2005
(86) PCT No.: PCT/IB2005/053985

§ 371 Date: Sep. 19, 2008

(30) Foreign Application Priority Data
Dec. 7, 2004 (EP) 04300853.1

(51) Int. Cl. H04N 7/46

(52) U.S. Cl. 382/298

(57) ABSTRACT

The method of reducing the size of an initial image into a final image, each image being formed by a matrix of ordered pixels, each pixel being characterised by a characteristic quantity (Cn), the reduction being effected by a ratio P/Q with P and Q integers and Q not a multiple of P, comprising a pixel decimation step, in which the following steps are implemented: —effecting a partitioning of the initial image into groups of pixels; —allocating, successively to each group of pixels n of the initial image, a coefficient μn the coefficients of the groups of pixels forming an arithmetic sequence of ratio P in Z/QZ defined by the recurrence relationship μn+1≡μn+P(Q); —selecting only the groups of pixels whose coefficient allocated is a number less than P−1; —decimating the groups of pixels not selected: and—forming the final image of reduced size solely from the groups of pixels selected, each pixel in the groups of pixels selected being characterised by the filtered characteristic quantity (C′n).

### FIELD OF THE INVENTION

The present invention relates to a method and device for reducing or enlarging the size of an initial image, each image being formed by a matrix of ordered pixels, each pixel being characterised by at least one characteristic quantity, the modification taking place with a ratio P/Q with P and Q integers and Q not a multiple of P.

### BACKGROUND OF THE INVENTION

Current digital images consist of a matrix of pixels of given size generally imposed by the sensor that generated the image. The size is defined by the number of rows and columns in the image.

For many applications, it is necessary to adapt the size of the image in order to reveal the image on a display with a format adapted to this display, which may be different from the size imposed by the sensor. In particular, it is often necessary to reduce the size of the image, for example in order to make it visible on a screen of reduced size such as those present on a digital camera or on a mobile telephone.

Image resizing algorithms must function in real time and have low complexity in order to allow low energy consumption and calculation time and finally require a reduced memory size, during use.

Amongst known algorithms, some provide a reduction in the size of an image by decimation at regular intervals of certain rows and certain columns of the image. Such an algorithm is described for example in the document GB-2.340.688.

When this elimination of columns or rows of pixels is carried out without filtering, a strong degradation of the quality of the image is found because of an aliasing of the spectrum transforming the high frequencies of the image input into low frequencies.

Other more advanced methods use, before the decimation step, a step of filtering of the high frequencies of the input image in order to reduce the problem of spectrum aliasing. The filtering takes place in a conventional manner using a filter of the ninth or eleventh order FIR (Finite Impulse Response) type.

A filter of this type requires a large number of multiplying and adding operators. To have good performance, the number of coefficients of the filter must be close to the decimation factor.

One method of reducing the size of an image using a filter of the FIR type is effective only if the number of coefficients of the filter is high and therefore the latter has very high complexity in use, which results in a high consumption of electrical and calculating power.

In particular, these methods are very ill suited to large reduction factors, around 50 to 100.

The aim of the invention is to propose means of reducing the size of an image and enlarging the size of an image which can give satisfactory results and whose implementation is simple and inexpensive in terms of calculation means.

### SUMMARY OF THE INVENTION

To this end, an object of the invention is a method of reducing the size of an image, the method comprising a step of filtering the characteristic quantities in order to form filtered characteristic quantities of filters and a pixel decimation step for obtaining the final image, in which the following steps are implemented:
effecting a partitioning of the initial image into groups of pixels;
allocating, successively to each group of pixels n of the initial image, a coefficient μn, the coefficients of the groups of pixels forming an arithmetic sequence of ratio P in Z/QZ defined by the recurrence relationship μₙ₊₁≡μₙ+P(Q);
selecting only the groups of pixels whose coefficient allocated is a number less than P−1;
decimating the groups of pixels not selected; and
forming the final image of reduced size solely from the groups of pixels selected, each pixel in the groups of pixels selected being characterised by the filtered characteristic quantity.

Although the calculation power necessary for implementing the method is low, the quality of the image is good, in particular because of the irregular intervals between the filtered pixels retained to form the reduced image. This irregular distribution of the retained pixels makes it possible to implement a filtering whose template depends on the number of pixels decimated.

In addition, an object of the invention is a method of enlarging the size of an initial image into a final image, each image being formed by a matrix of ordered pixels, each pixel being characterised by at least one characteristic quantity, the enlargement taking place by a ratio P/Q with P and Q integers and P not a multiple of Q, the method comprising a step of duplication of pixels in order to obtain the final image, in which the following steps are implemented:
effecting a partitioning of the initial image into groups of pixels;
allocating, successively to each group of pixels n of the initial image, a coefficient μₙ, the coefficients of the groups of pixels forming an arithmetic sequence of ratio P in Z/QZ defined by the recurrence relationship μₙ₊₁≡μₙ+P(Q);
duplicating the groups of pixels until the allocated coefficient is a number less than P−1; and
forming the final image of reduced size from groups of pixels of the initial image and groups of duplicated pixels.

Another object is a computer program product for a computer processing unit comprising a set of instructions for executing the steps of a method as defined above, when said program is executed by a computer processing unit.

Another object of the invention is a device for reducing the size of an initial image into a final image, each image being formed by a matrix of ordered pixels, each pixel being characterised by at least one characteristic quantity, the reduction taking place by a ratio P/Q with P and Q integers and Q not a multiple of P, the device comprising means of filtering the characteristic quantities in order to form filtered characteristic quantities of pixels and pixel decimation means for obtaining the final image, in which the device also comprises:
means for effecting a partitioning of the initial image into groups of pixels,
means for allocating, successively to each group of pixels n of the initial image, a coefficient en, the coefficients of the groups of pixels forming an arithmetic sequence of ratio P in Z/QZ defined by the recurrence relationship μₙ₊₁≡μₙ+P(Q);
means for selecting solely the groups of pixels whose allocated coefficient is a number less than P−1;
means for decimating the groups of pixels not selected; and
means for forming the final image of reduced size solely from the groups of selected pixels, each pixel in the groups of selected pixels being characterised by the filtered characteristic quantity.

Finally, one of its objects is a device for enlarging the size of an initial image into a final image, each image being formed by a matrix of ordered pixels, each pixel being characterised by at least one characteristic quantity, the enlargement taking place by a ratio P/Q with P and Q integers and P not a multiple of Q, the device comprising pixel duplication means for obtaining the final image, in which the device comprises:
means for effecting a partitioning of the image into groups of pixels,
means for allocating, successively to each group of pixels n of the final image, a coefficient μₙ, the coefficients of the groups of pixels forming an arithmetic sequence of ratio P in Z/QZ defined by the recurrence relationship μₙ₊₁≡μₙ+P(Q);
means for duplicating the groups of pixels until the coefficient allocated is a number less than P−1; and
means for forming the final image of reduced size from groups of pixels of the initial image and groups of duplicated pixels.

### BRIEF DESCRIPTION OF THE DRAWING

The invention will be further described with reference to examples of embodiments shown in the drawings to which, however, the invention is not restricted.

FIG. 1 is a schematic view of the structure of equipment for taking digital images and reducing their size;

FIG. 2 is a schematic view of the horizontal reduction module of the equipment of FIG. 1;

FIG. 3 is a flow diagram of the method implemented for reducing image size;

FIG. 4 is a histogram explaining the algorithm for choosing pixels to be kept;

FIG. 5 is an illustration of the successive values taken by the decimation counter; and

FIG. 6 is a schematic view of the vertical reduction module of the equipment of FIG. 1.

### DESCRIPTION OF PREFERRED EMBODIMENTS

The method of modifying the size of an image is particularly adapted for being implemented in portable equipment for acquiring video sequences or fixed images such as a mobile telephone equipped with an integral camera and means of transmitting the video sequence or image acquired after it has been compressed.

The invention is particularly useful for a modification of the size according to a ratio P/Q with P and Q integers, Q and P being prime with each other, that is to say not being multiples of each other.

Hereinafter the description will be given in the case of the reduction of the size of an image, that is to say Q>P.

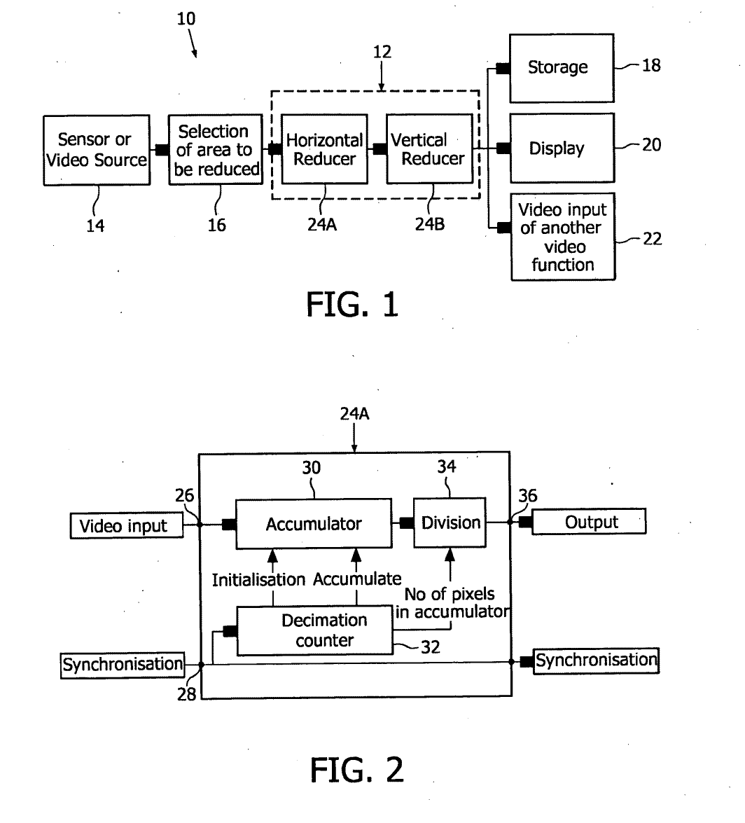

FIG. 1 depicts schematically the structure of portable acquisition equipment comprising a stage 12 for reducing the size of an image.

The processing chain of the equipment 10 comprises means 14 of acquiring a digital image consisting for example of the lens of a camera associated with a matrix of sensors.

The digital image acquired is formed from a matrix of pixels. Each pixel constitutes an image element characterised by various characteristic quantities such as luminance, green chrominance, blue chrominance and red chrominance, or the red component, the green component and the blue component.

The images acquired have a predefined size, for example 640×480 pixels.

At the output from the sensor 14 there is provided a module 16 for selecting an area of the image that is to be reduced. This module makes it possible to determine a sub-image contained in the initial image to which the reduction is to relate.

The reduction stage 12 is provided at the output from the selection module in order to receive the matrix pixels defining the sub-image that is to be reduced.

At the output from the image reduction stage, the equipment comprises one or more modules for using the reduced image such as a storage memory 18, a display 20 of reduced size and/or another processing module such as means of sending the reduced image through a communication network.

The reduction stage 12 comprises successively a horizontal reduction module 24A and a vertical reduction module 24B.

The horizontal reduction module 24A is able to filter and decimate elementary pixels according to rows of pixels constituting the image.

The vertical reduction module, on the other hand, is able to decimate entire rows of pixels by filtering the characteristic values of the pixels along columns.

The structure of the horizontal reduction module is illustrated in FIG. 2.

The module illustrated in FIG. 2 is duplicated for each characteristic quantity of the pixels.

This comprises an input 26 for receiving the video signal and more precisely a succession of characteristic quantities for the ordered pixels according to an image description mode.

In addition, it comprises a synchronisation input 28 for receiving a clock signal defining the input frequency of the characteristic quantities of the pixels from the input 26.

The horizontal reduction module 24A comprises an accumulator 30 receiving as an input the characteristic quantities of the pixels issuing from the input 26. This accumulator is in practice an adder able to calculate the sum of the characteristic quantities received as an input.

The accumulator 30 comprises an initialisation input for resetting it to zero. In addition, the reduction module 24A comprises a decimation counter 32, a control output of which is connected to the initialisation output of the accumulator. The decimation counter 32 is connected so as to receive, as an input, the synchronisation signal issuing from the input 28.

The decimation counter 32 is able to count the number of characteristic quantities received by the accumulator 30 since the last reinitialisation from the number of corresponding clock signals received from the synchronisation input and to apply an algorithm controlling the accumulator. In particular, the decimation counter 32 comprises a control input for the accumulator able to send an instruction to the accumulator for the transfer of the sum of the characteristic values accumulated to a division unit 34 of the reduction module whose input is connected to be output of the accumulator.

The division unit 34 comprises an input connected at the output of the decimation counter 32 able to receive the number of characteristic quantities received by the accumulator since the last initialisation.

The output denoted 36 of the reduction module is connected to the output of the division unit 34. Through this output, the reduction module is able to successively supply a set of ordered characteristic quantities corresponding to the successive pixels of an image of reduced size horizontally.

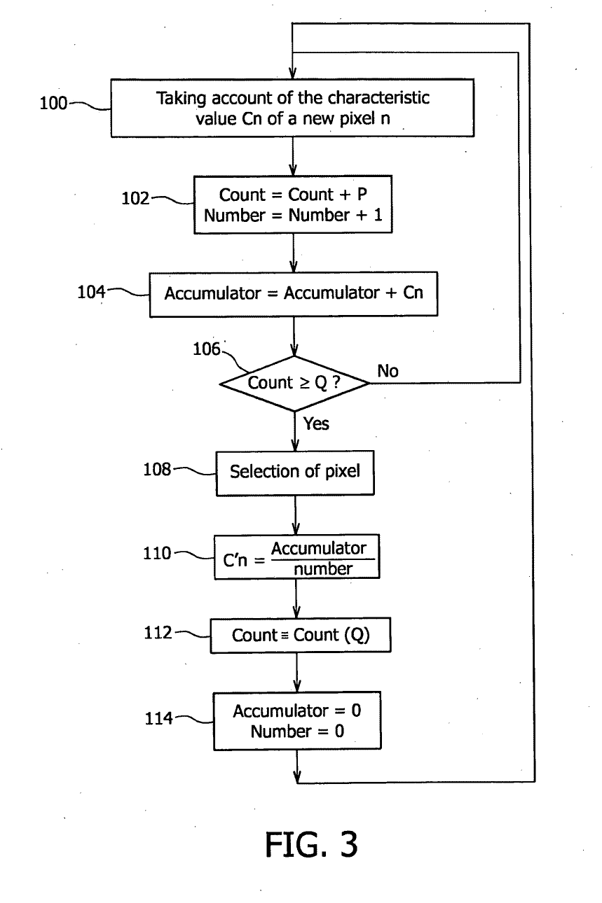

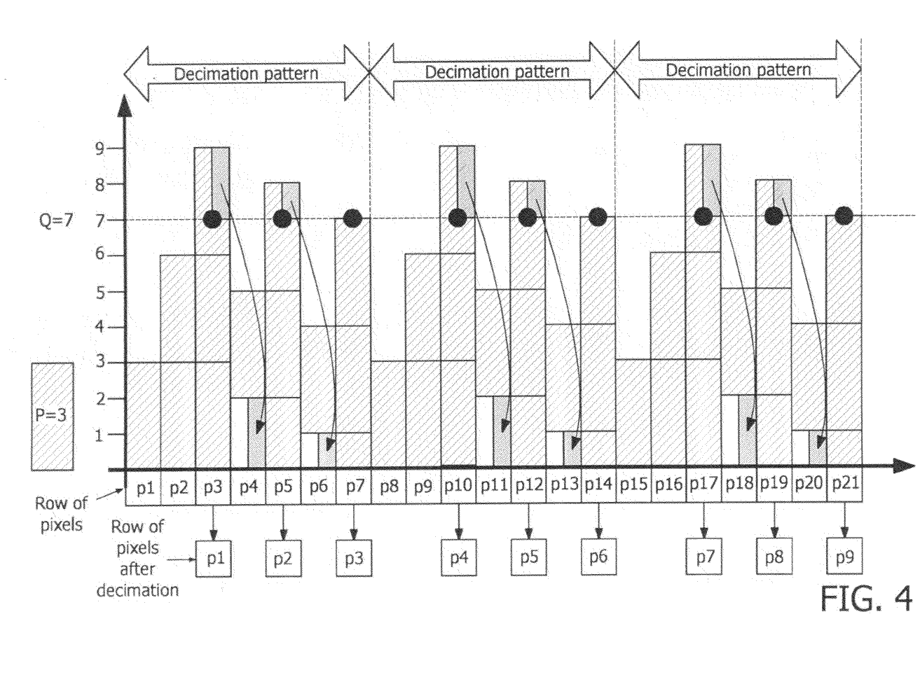

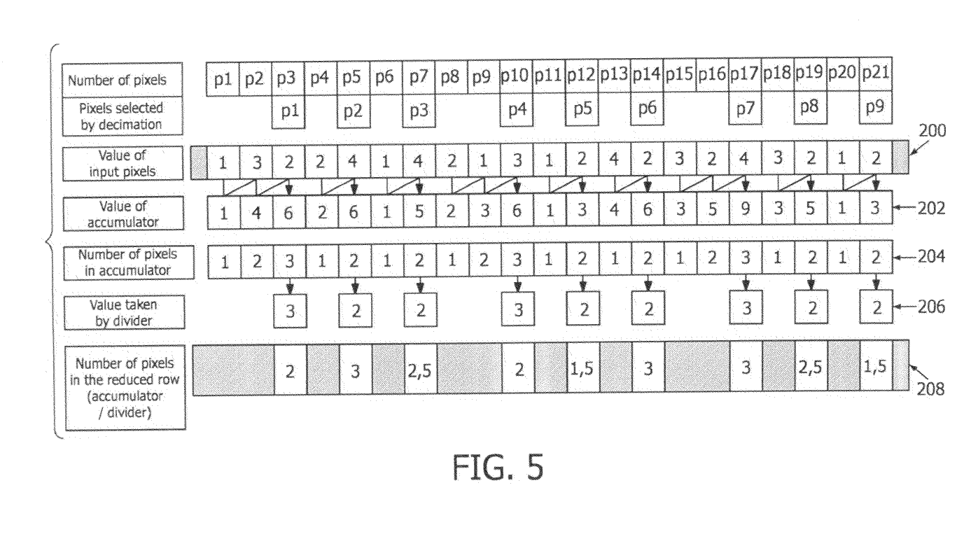

The image reduction method implemented under the control of the decimation counter 32 will be described with regard to FIG. 3 whilst being illustrated in FIGS. 4 and 5. The algorithm used successively processes each of the characteristic quantities of the pixels of the initial image ordered in a predefined representation mode.

Thus a characteristic quantity of a pixel is first of all sent, at step 100, to the accumulator 30. Simultaneously, at step 102, a first counter denoted COUNT is incremented by the value P equal to the numerator of the rational reduction ratio denoted P/Q. A second counter denoted NUMBER is incremented by the value 1. The purpose of this counter is to count the number of characteristic quantities of pixels being added in the accumulator 30.

At step 104, the accumulator adds to the values previously added the last characteristic quantity taken into account denoted Cn for the pixel n.

At step 106, the value of the counter COUNT is compared to the value of Q, Q being the denominator of the reduction ratio P/Q.

If the value of the counter COUNT is less than Q, the steps 100 et seq are once again implemented for the following pixel. On the other hand, if the counter COUNT is greater than Q, that is to say the value of the counter COUNT modular Q in Z/QZ (Z is all the relative integers) is between zero and P−1, a characteristic quantity for a new pixel of the image of reduced sizes calculated by the division unit 34. For this purpose, the decimation counter 32 demands the transfer at step 108 of the sum COUNT of the characteristic quantities accumulated to the divider 34, which also receives the value of the counter NUMBER from the decimation counter 32.

This procedure amounts to allocating to each pixel a coefficient μₙ forming an arithmetic series of ratio P in Z/QZ defined by the recurrence relationship μₙ₊₁≡μₙ+P(Q).

From these values, it determines the characteristic value C′n of the pixel of the reduced image by, at step 110, dividing the value of the accumulator COUNT by the number of pixels defined by the counter NUMBER.

At step 112, the counter COUNT managed by the decimation of counter 32 is reinitialised to the previous value of the counter COUNT decremented by Q.

At step 114, the accumulator COUNT is reset to zero as well as the counter NUMBER.

For the following pixels on the same line, the steps 100 et seq are once again implemented until all the pixels constituting the initial image are finished.

The functioning of the counter 32 for triggering the calculation of a new filtered characteristic quantity for a new pixel of the image of reduced size is illustrated in FIG. 4. In this figure the pixels P1 to P21 of the initial image appear on the X axis and the values taken for each pixel by the counter COUNT appear on the Y axis. In the case in question, the ratio is fixed at 3/7 so that the step P is equal to 3 whilst the threshold Q is equal to 7.

In this case, for the first two pixels, the counter COUNT takes the values 3 and 6, which are less than 7. On the other hand, for the third pixel, the counter COUNT takes, the value 9, which is greater than 7, so that a first pixel P1 is defined for the image of reduced size. For the fourth pixel, the counter is equal to the previous value of the counter modulo 7, that is to say equal to 2 with the step P added so that the counter COUNT is equal to 5.

Thus, progressively and by repetition of the incrementation process of the counter COUNT and comparison with the threshold Q, new pixels are defined.

In FIG. 5 an example is illustrated of the characteristic quantities taken for the input pixels in the row 200. The corresponding values of the accumulator are defined on row 202 and correspond to the sum of the characteristic quantities of the pixels since the initialisation of the accumulator 30. Row 204 indicates the value of the counter NUMBER representing the number of characteristic quantities corresponding to a pixel in the accumulator.

Finally, in row 206 there are indicated the values sent to the division unit 34 for calculating a new characteristic quantity of a pixel of the image of reduced size. This characteristic value is illustrated on row 210.

Thus, since P and Q are prime with each other, the filter can be considered to be heterogeneous given that its impulse response (or the filter order) changes during the decimation. In the example where the decimation ratio is 7/3, the following filters are concatenated sequentially at the time of decimation:

[1 1 1]/3
[1 1]/2
[1 1]/2

In another example where the decimation ratio is 7/5, the following filters are concatenated:

[1 1]/2

[1]/1

[1 1]/2

[1]/1

[1]/1

At high decimation factors, the algorithm has a good quality to price ratio. Factors of around 100 or even 200 can be envisaged without visible loss of quality. This is because the quality of the algorithm is independent of the decimation factor.

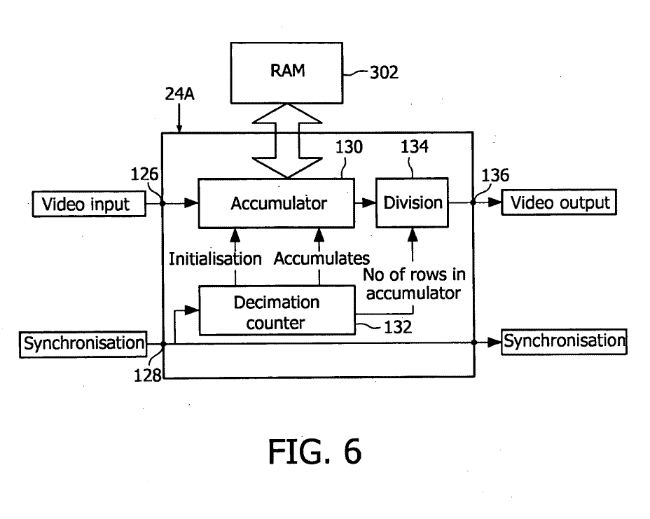

FIG. 6 depicts schematically the vertical reduction module 24B. This repeats the elements of the horizontal reduction module, which bear the same reference numbers, to which 100 has been added. However, this reduction module receives as an input not pixels but rows of pixels so that the accumulator 130 is associated with a row memory 302 consisting for example of a memory of the RAM type making it possible to temporarily store all the characteristic values for each row entered in the accumulator. For the vertical reduction, the accumulator provides the sum of the characteristic quantities of the pixels of the same rank of the successive rows received.

More precisely, the accumulator 130 of the vertical reduction module 24B receives as an input rows of pixels comprising a number of pixels already reduced because of the action of the horizontal reduction modules 24A.

The decimation counter counts the number of row received by the accumulator since the last initialisation. Under the control of the decimation counter 132, the accumulator 130 proceeds with the progressive accumulation of the pixels of rows received, effecting the quantities of the characteristic values of the pixels of the same rank, that is to say the rows are totalled by pixel.

When the row counter COUNT is greater than or equal to Q, the decimation counter 32 demands the transfer to the divider 134 of the accumulated quantities and of the number of rows received, so that the divider 34 provides, for each pixel, the quotient of the sum of the characteristic quantities of pixels of the rows thus accumulated and divided by the number of rows.

The method described previously can be implemented also for the enlargement of images by a ratio P/Q with P greater than Q and P not a multiple of Q. In this case, the enlargement is effected by inserting certain pixels and certain rows of the image in successive horizontal and vertical enlargement modules.

These pixels or rows inserted correspond to the duplication of the pixel or corresponding row in question.

Unlike the reduction of the size of the image, there is determined from an algorithm like the one described with regard to FIG. 4 not the number of pixels or rows to be decimated but on the contrary the number of pixels or rows that are to be duplicated. Thus pixels or rows of pixels are duplicated and each allocated a coefficient μₙ defined by the recurrence relationship μₙ₊₁≡μₙ+P(Q) as long as tin is not less than P−1.

Advantageously, the horizontal and/or vertical reduction modules are implemented by an information processing unit functioning under the control of a computer program, the said program being able, when it is implemented on the processing unit, to apply at least one of the algorithms described above.

1. Method of reducing the size of an initial image into a final image, each image being formed by a matrix of ordered pixels, each pixel being characterised by at least one characteristic quantity (Cn), the reduction being effected by a ratio P/Q with P and Q integers and Q not a multiple P, the method comprising a step of filtering characteristic quantities (Cn) in order to form filtered characteristic quantities (C′n) of pixels and a pixel decimation step in order to obtain the final image, in which the following steps are implemented:
effecting a partitioning of the initial image into groups of pixels;
allocating, successively to each group of pixels, N of the initial image, a coefficient μₙ the coefficients of the groups of pixels forming an arithmetic sequence of ratio P in Z/QZ defined by the recurrence relationship μₙ₊₁≡μₙ+P(Q);
selecting only the groups of pixels whose coefficient allocated is a number less than P−1;
decimating the groups of pixels not selected; and
forming the final image of reduced size solely from the groups of pixels selected, each pixel in the groups of pixels selected being characterised by the filtered characteristic quantity (C′n).

2. Method as claimed in claim 1, in which the filtered characteristic quantity (C′n) of one or each pixel in a selected group forming the final image is a linear combination of the characteristic quantities of the pixels in the decimated groups of the initial image close to the or each pixel in the selected group and the characteristic quantity of the or each pixel in the selected group.

3. Method as claimed in claim 2, in which the filtered characteristic quantity (C′n) of one or each pixel in a selected group forming the final image is a linear combination of the characteristic quantities of the or each pixel in the selected group and the characteristic quantities of the pixels in the decimated groups of the initial image included between the or each pixel in the selected group and the or each pixel in the previous selected group.

4. Method as claimed in claim 3, in which the filtered characteristic quantity (C′n) of one or each selected pixel forming the final image is the sum of the characteristic quantities of the decimated pixels included between the or each pixel in the selected group and the or each pixel in the previous selected group and the or each pixel in the selected group divided by the number of groups of decimated pixels included between the or each pixel in the selected group and the or each pixel in the previous selected group plus one.

5. Method as claimed in claim 4, characterised in that the step of allocating a coefficient (μₙ) to each group of pixels comprises a step of calculating the coefficient (μₙ₊₁) of a group (n+1) of following pixels from the coefficient (μₙ) of the previous group of pixels by adding P and decrementing the coefficient of the following group of pixels (μₙ₊₁) of Q if the previous coefficient (μₙ) of the group of pixels (n) is greater than Q, and in that the step of selecting the groups of pixels comprises a step of comparing the characteristic quantity of each group of pixels with the threshold Q and selecting only the groups of pixels where the characteristic quantity is greater than or equal to Q.

6. A method of reducing the size, characterised in that it comprises a step of reducing, in a first direction, the size of an initial image by implementing a method according to claim 1, each group of pixels comprising a single pixel followed by a step of reducing in a second direction the size of the image reduced in the first direction according to claim 1, each group of pixels comprising a row of pixels in the image reduced in the first direction.

7. Method of enlarging the size of an initial image into a final image, each image being formed by a matrix of ordered pixels, each pixel being characterised by at least one characteristic quantity (Cn), the enlargement taking place by a ratio P/Q with P and Q integers and P not a multiple of Q, the method comprising a step of duplication of pixels in order to obtain the final image, in which the following steps are implemented:
effecting a partitioning of the initial image into groups of pixels;
allocating, successively to each group of pixels n of the initial image, a coefficient μₙ the coefficients of the groups of pixels forming an arithmetic sequence of ratio P in Z/QZ defined by the recurrence relationship μₙ₊₁≡μₙ+P(Q);
duplicating the groups of pixels until the allocated coefficient is a number less than P−1; and
forming the final image of reduced size from groups of pixels of the initial image and groups of duplicated pixels.

8. Computer program product for a computer processing unit, comprising a set of instructions for executing the steps of the method according to claim 1, when said program is executed by a computer processing unit.

9. Device for reducing the size of an initial image into a final image, each image being formed by a matrix of ordered pixels, each pixel being characterised by at least one characteristic quantity (Cn), the reduction taking place by a ratio P/Q with P and Q integers and Q not a multiple of P, the device comprising means of filtering the characteristic quantities (Cn) in order to form filtered characteristic quantities (C′n) of pixels and pixel decimation means for obtaining the final image, in which the device also comprises:
means for effecting a partitioning of the initial image into groups of pixels, means for allocating, successively to each group of pixels n of the initial image, a coefficient μₙ, the coefficients of the groups of pixels forming an arithmetic sequence of ratio P in Z/QZ defined by the recurrence relationship μₙ₊₁≡μₙ+P(Q);
means for selecting solely the groups of pixels whose allocated coefficient is a number less than P−1;
means for decimating the groups of pixels not selected; and
means forming the final image of reduced size solely from the groups of selected pixels, each pixel in the groups of selected pixels being characterised by the filtered characteristic quantity (C′n).

10. Device for enlarging the size of an initial image into a final image, each image being formed by a matrix of ordered pixels, each pixel being characterised by at least one characteristic quantity (Cn), the enlargement taking place by a ratio P/Q with P and Q integers and P not a multiple of Q, the device comprising pixel duplication means for obtaining the final image, in which the device comprises:
means for effecting a partitioning of the image into groups of pixels,
means for allocating, successively to each group of pixels n of the final image, a coefficient μₙ, the coefficients of the groups of pixels forming an arithmetic sequence of ratio P in Z/QZ defined by the recurrence relationship μₙ₊₁≡μₙ+P(Q);
means for duplicating the groups of pixels until the coefficient allocated is a number less than P−1; and
means for forming the final image of reduced size from groups of pixels of the initial image and groups of duplicated pixels.
